(19) United States
(12) Patent Application Publication
(10) Pub. No.: US 2025/0219476 A1
(43) Pub. Date: Jul. 3, 2025

(54) ROTATING ELECTRIC MACHINE

(71) Applicant: Murata Manufacturing Co., Ltd., Nagaokakyo-shi (JP)

(72) Inventors: Kazuki IWASAKI, Nagaokakyo-shi (JP); Mitsutoshi NATSUMEDA, Nagaokakyo-shi (JP)

(21) Appl. No.: 19/081,197

(22) Filed: Mar. 17, 2025

Related U.S. Application Data
(63) Continuation of application No. PCT/JP2023/047197, filed on Dec. 28, 2023.

(30) Foreign Application Priority Data
Jan. 23, 2023 (JP) 2023-007813

(51) Int. Cl. H02K 1/14

(52) U.S. Cl. CPC H02K 1/146

(57) ABSTRACT

A rotating electric machine includes: a rotor including a magnetized hard magnetic body; and a magnetic core including a tooth portion. The tooth portion includes a tooth body portion that extends along a direction that intersects a rotation axis of the rotor; and a tooth tip portion at a tip of the tooth body portion and that faces the magnetized hard magnetic body. The tooth tip portion includes a first protruding portion protruding from the tooth body portion in an axial direction along the rotation axis. A protrusion amount of the first protruding portion from the tooth body portion is smaller than three times a gap width between the magnetized hard magnetic body and the tooth tip portion.

### CROSS REFERENCE TO RELATED APPLICATIONS

The present application is a continuation of International application No. PCT/JP2023/047197, filed Dec. 28, 2023, which claims priority to Japanese Patent Application No. 2023-007813, filed Jan. 23, 2023, the entire contents of each of which are incorporated herein by reference.

### TECHNICAL FIELD

The present disclosure relates to a rotating electric machine.

### BACKGROUND ART

As an invention related to a rotating electric machine of the related art, for example, a motor described in Patent Document 1 has been known. The motor described in Patent Document 1 includes a shaft serving as a rotation center when a rotor is rotated with respect to a stator, a magnet attached to the rotor and magnetized to alternately different poles in a circumferential direction around the shaft, an iron core attached to the stator and facing the magnet in a radial direction around the shaft, a coil wound around the iron core, and a magnetic shielding member. The magnetic shielding member shields the coil against leakage magnetic flux from the magnet.
Patent Document 1: Japanese Unexamined Patent Application Publication No. 2008-245427

### SUMMARY OF THE DISCLOSURE

There is a demand in the motor described in Patent Document 1 for increasing back electromotive force generated between both ends of the coil by increasing a back electromotive force constant while the magnetic shielding member is reduced.

Thus, an object of the present disclosure is to provide a rotating electric machine in which a back electromotive force constant can be increased while the magnetic shielding member is reduced.

A rotating electric machine according to an aspect of the present disclosure is a rotating electrical machine including: a rotor including a magnetized hard magnetic body; and a magnetic core including a tooth portion, wherein the tooth portion includes: a tooth body portion extending along a direction that intersects a rotation axis of the rotor, and a tooth tip portion at a tip of the tooth body portion and facing the magnetized hard magnetic body, the tooth tip portion includes a first protruding portion protruding from the tooth body portion in an axial direction along the rotation axis, and a first protrusion amount of the first protruding portion from the tooth body portion is smaller than three times a gap width between the magnetized hard magnetic body and the tooth tip portion.

According to the present disclosure, it is possible to provide a rotating electric machine in which a back electromotive force constant can be increased while the magnetic shielding member is reduced.

### BRIEF DESCRIPTION OF THE DRAWINGS

FIG. 1 is an external perspective view of a brushless motor 100.

FIG. 2 is an exploded schematic perspective view of the brushless motor 100.

FIG. 3 is a perspective view of a magnetic core 1.

FIG. 4 is a cross-sectional view of a hard magnetic body 24 and one magnetic core 1 as viewed in the direction orthogonal to a first direction DIR1 and a third direction DIR3.

FIG. 5 is a cross-sectional view of the hard magnetic body 24, and one magnetic core 6 according to a comparative example, as viewed in the direction orthogonal to the first direction DIR1 and the third direction DIR3.

FIG. 6 is a diagram illustrating portions where magnetic flux density is calculated.

FIG. 7 is a graph showing an example of changes in magnetic flux density in a case where a first protrusion amount D1 and a second protrusion amount D2 are changed when an offset amount DO is 0.1 mm and a gap width DA is 0.5 mm.

FIG. 8 is a graph showing an example of changes in magnetic flux density in a case where the first protrusion amount D1 and the second protrusion amount D2 are changed when the offset amount DO is 0.2 mm and the gap width DA is 0.5 mm.

FIG. 9 is a graph showing an example of a change in a back electromotive force constant KE in a case where the first protrusion amount D1 and the second protrusion amount D2 are changed when the offset amount DO is 0.2 mm and the gap width DA is 0.5 mm.

FIG. 10 is a graph showing an example of a change in the back electromotive force constant KE in a case where the first protrusion amount D1 and the second protrusion amount D2 are changed when the offset amount DO is 0.2 mm and the gap width DA is 0.3 mm.

### DESCRIPTION OF THE PREFERRED EMBODIMENTS

### Embodiment

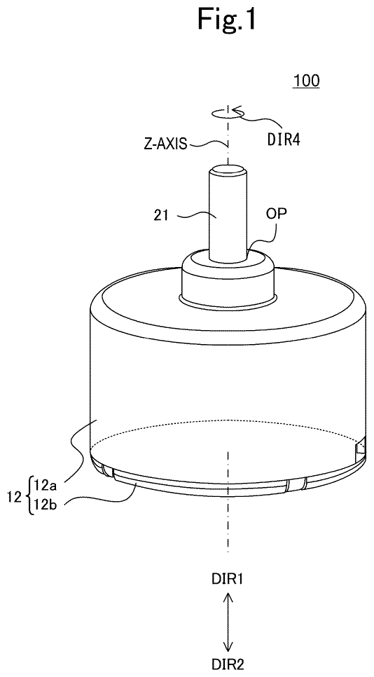

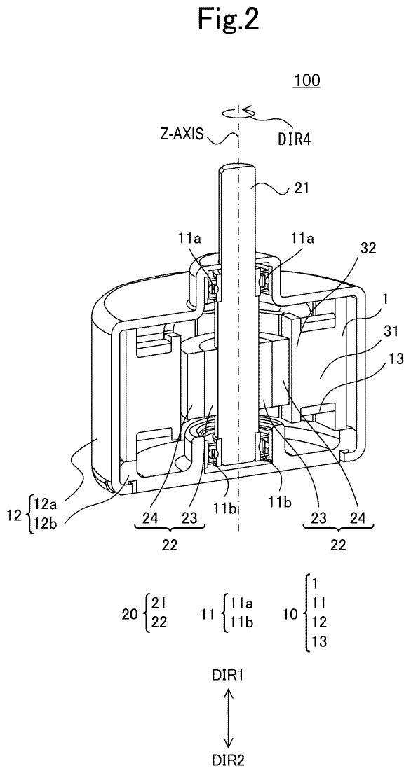

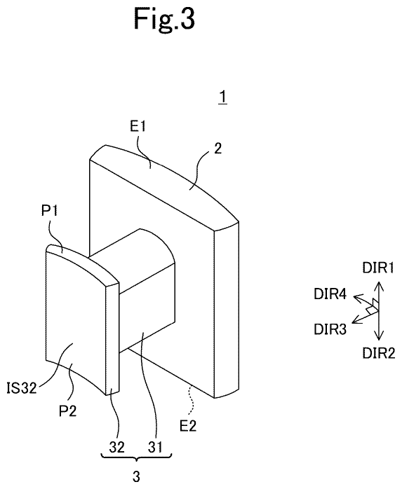

Hereinafter, a configuration of the brushless motor 100 according to an embodiment of the present disclosure will be described with reference to the drawings. FIG. 1 is an external perspective view of the brushless motor 100. FIG. 2 is an exploded schematic perspective view of the brushless motor 100. FIG. 3 is a perspective view of the magnetic core 1.

In addition, in the present specification, directions are defined as follows. Of axial directions along a rotation axis of a rotor 20, a direction in which a shaft 21 protrudes outward from a housing 12 through an opening OP is defined as the first direction DIR1. A direction opposite to the first direction DIR1 is defined as a second direction DIR2. A direction that is one of radial directions around the rotation axis of the rotor 20 and that is directed from a geometric center of a tooth tip portion 32 toward the rotation axis of the rotor 20 when viewed in the first direction DIR1 is defined as the third direction DIR3. Of circumferential directions around the rotation axis of the rotor 20, a direction counterclockwise with respect to the rotation axis of the rotor 20 when viewed in the second direction DIR2 is defined as a fourth direction DIR4. Note that the definition of the directions in the present specification is an example.

As illustrated in FIG. 2, the brushless motor 100 includes the rotor 20 and a stator assembly 10. The stator assembly 10 is disposed around the rotor 20 when viewed in the first direction DIR1. That is, the brushless motor 100 is a brushless motor of an inner rotor type. Note that the brushless motor 100 is an example of a rotating electric machine according to the present disclosure.

As illustrated in FIG. 2, the rotor 20 includes the shaft 21 and a rotor member 22. The shaft 21 has a columnar shape extending in the first direction DIR1. The rotor member 22 has a cylindrical shape extending in the first direction DIR1. A center axis line of each of the shaft 21 and the rotor member 22 is a Z-axis. That is, a rotation axis of the brushless motor 100 is the Z-axis. Thus, each of the first direction DIR1 and the second direction DIR2 is a direction along the Z-axis.

As illustrated in FIG. 2, the rotor member 22 includes a soft magnetic body 23 and the hard magnetic body 24. The rotor member 22 is attached to an outer peripheral surface of the shaft 21 in a radial direction around the Z-axis. More specifically, the soft magnetic body 23 is attached to the outer peripheral surface of the shaft 21 in the radial direction around the Z-axis. The hard magnetic body 24 is attached to an outer peripheral surface of the soft magnetic body 23 in the radial direction around the Z-axis.

The soft magnetic body 23 is a soft magnetic body. Further, the hard magnetic body 24 is a hard magnetic body magnetized. The hard magnetic body is magnetized when a magnetic field is applied from outside. Thereafter, even when the application of the magnetic field is stopped, the hard magnetic body does not lose magnetization.

As illustrated in FIG. 2, the stator assembly 10 includes a bearing 11, the housing 12, a coil 13, and the magnetic core 1.

The bearing 11 supports the shaft 21 so as to be rotatable in a circumferential direction around the Z-axis. More specifically, as illustrated in FIG. 2, the bearing 11 includes a first bearing 11a and a second bearing 11b. Each of the first bearing 11a and the second bearing 11b is, for example, a ball bearing. Each of the first bearing 11a and the second bearing 11b has a cylindrical shape extending in the first direction DIR1. A center axis line of each of the first bearing 11a and the second bearing 11b is the Z-axis. That is, the center axis line of each of the first bearing 11a and second bearing 11b coincides with the center axis line of the shaft 21.

As illustrated in FIG. 2, the second bearing 11b is located further in the second direction DIR2 than the first bearing 11a. In addition, the first bearing 11a is located further in the first direction DIR1 than the rotor member 22. The second bearing 11b is located further in the second direction DIR2 than the rotor member 22. The second bearing 11b supports an end of the shaft 21 in the second direction DIR2.

As illustrated in FIG. 1, the housing 12 includes a first housing 12a and a second housing 12b. The first housing 12a has a cylindrical shape as illustrated in FIG. 1 and FIG. 2. A center axis line of the first housing 12a is the Z-axis. The first housing 12a is located further in the first direction DIR1 than the second housing 12b. Further, the first housing 12a includes the opening OP. Thus, the shaft 21 protrudes from the opening OP in the first direction DIR1. That is, the brushless motor 100 is a brushless motor of a single-shaft type.

The first housing 12a supports the first bearing 11a, a plurality of magnetic cores 1, and a plurality of coils 13. The second housing 12b supports the second bearing 11b. A material of each of the first housing 12a and the second housing 12b is, for example, a material having high rigidity such as SUS.

Nine coils 13 and nine magnetic cores 1 are provided. The nine coils 13 and the nine magnetic cores 1 are arranged in the circumferential direction around the Z-axis. The nine magnetic cores 1 are disposed around the hard magnetic body 24 with an interval between the hard magnetic body 24 and the magnetic cores 1.

As illustrated in FIG. 3, the magnetic core 1 includes a core back portion 2 and a tooth portion 3. The tooth portion 3 has a shape extending from the core back portion 2 in the third direction DIR3. More specifically, the tooth portion 3 includes a tooth body portion 31 extending from the core back portion 2 in the third direction DIR3, and the tooth tip portion 32 formed at a tip of the tooth body portion 31. As illustrated in FIG. 2, the coil 13 is wound around the tooth body portion 31.

The magnetic core 1 is a soft magnetic body. The soft magnetic body is magnetized when a magnetic field is applied from outside. Thereafter, when the application of the magnetic field is stopped, the soft magnetic body loses magnetization. A material of such a soft magnetic body is, for example, iron.

The magnetic core 1 is a molded body formed of soft magnetic powder. That is, each of the core back portion 2 and the tooth portion 3 is a molded body formed of soft magnetic powder. A material of the soft magnetic powder contains, for example, iron and a binding material. The binding material is, for example, resin. The soft magnetic powder is, for example, obtained by mixing iron powder and an epoxy resin, which is an example of the binding material. Such a magnetic core 1 is manufactured by, for example, press molding. Further, an outer surface of the magnetic core 1 in contact with another member is subjected to an insulation treatment.

As illustrated in FIG. 3, the core back portion 2 includes a first end surface E1 and a second end surface E2 arranged in the first direction DIR1, an inner main surface and an outer main surface arranged in the third direction DIR3, and two side surfaces arranged in the fourth direction DIR4. The first end surface E1 is located further in the first direction DIR1 than the second end surface E2. The inner main surface is located further in the third direction DIR3 than the outer main surface. In the present embodiment, each of the first end surface E1, the second end surface E2, and the inner main surface is a flat surface. Each of the outer main surface and the two side surfaces is a curved surface.

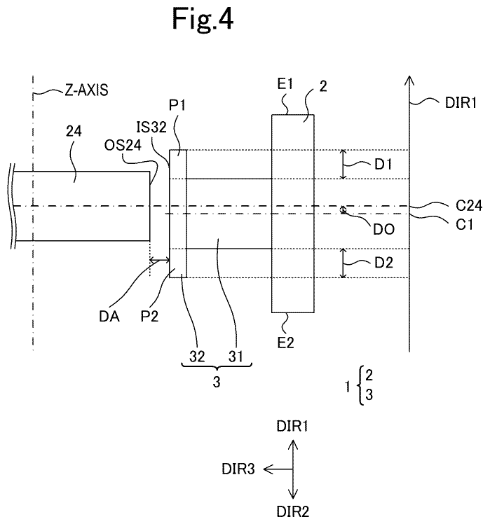

FIG. 4 is a cross-sectional view of the hard magnetic body 24 and one magnetic core 1 as viewed in the direction orthogonal to the first direction DIR1 and the third direction DIR3. As illustrated in FIG. 3 and FIG. 4, the tooth tip portion 32 includes a first protruding portion P1 and a second protruding portion P2. The first protruding portion P1 protrudes from the tooth body portion 31 in the first direction DIR1. A protrusion amount of the first protruding portion P1 from the tooth body portion 31 in the first direction DIR1 is defined as the first protrusion amount D1. The second protruding portion P2 protrudes from the tooth body portion 31 in the second direction DIR2. A protrusion amount of the second protruding portion P2 from the tooth body portion 31 in the second direction DIR2 is defined as the second protrusion amount D2. The first protruding portion P1 is located further in the second direction DIR2 than the first end surface E1. Further, the second protruding portion P2 is located further in the first direction DIR1 than the second end surface E2. That is, each of the first protruding portion P1 and the second protruding portion P2 is located between the first end surface E1 and the second end surface E2 in the first direction DIR1.

As illustrated in FIG. 2 and FIG. 4, the tooth tip portion 32 faces the hard magnetic body 24. More specifically, as illustrated in FIG. 4, an inner main surface IS32 of the tooth tip portion 32 in the third direction DIR3 faces an outer peripheral surface OS24 of the hard magnetic body 24 in the third direction DIR3. Additionally, as illustrated in FIG. 2, a void (air gap) is present between the magnetic core 1 and the rotor member 22. More specifically, as illustrated in FIG. 4, the void (air gap) is present between the inner main surface IS32 of the tooth tip portion 32 and the outer peripheral surface OS24 of the hard magnetic body 24. A distance between the tooth tip portion 32 and the hard magnetic body 24 is defined as the gap width DA. In the present embodiment, the gap width DA is a distance between the inner main surface IS32 and the outer peripheral surface OS24 in the third direction DIR3. In addition, in the present embodiment, a magnetic center C24 of the hard magnetic body 24 and a magnetic center C1 of the magnetic core 1 are shifted from each other in the first direction DIR1. More specifically, the magnetic center C24 of the hard magnetic body 24 is located further in the first direction DIR1 than the magnetic center C1 of the magnetic core 1. A distance between the magnetic center C24 of the hard magnetic body 24 and the magnetic center C1 of the magnetic core 1 in the first direction DIR1 is defined as the offset amount DO.

The coil 13 is made of, for example, a conductive material such as copper. Further, the coil 13 has a structure in which a surface of a copper wire is covered with an insulating film. The coil 13 has the structure in which the surface of the copper wire is covered with the insulating film, and thus is electrically insulated from the magnetic core 1.

A current from a power source (not illustrated) is supplied to the coil 13. The coil 13 generates a magnetic field when a current flows through the coil 13. The magnetic core 1 is magnetized by each of a magnetic field generated by the hard magnetic body 24 and the magnetic field generated by the coil 13. Rotation of the rotor 20 is controlled by controlling a current supplied from a power source (not illustrated).

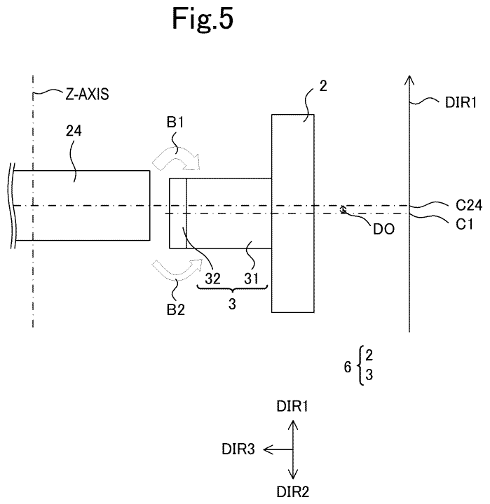

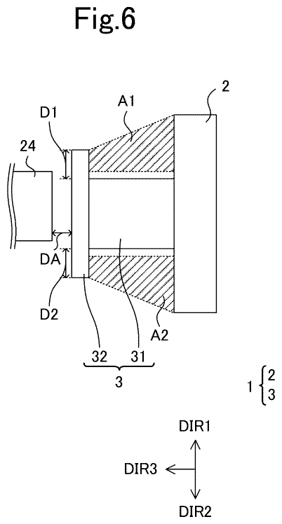

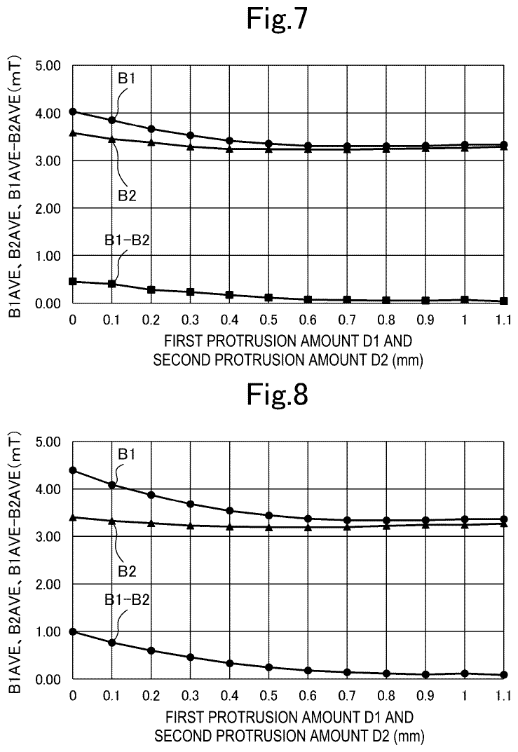

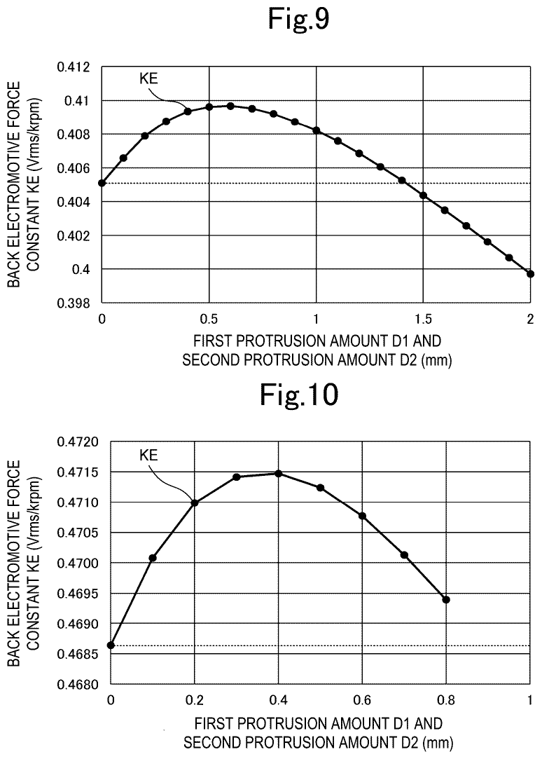

The brushless motor 100 has a structure with which the back electromotive force constant KE can be increased while the magnetic shielding member is reduced. This structure will be described below. FIG. 5 is a cross-sectional view of the hard magnetic body 24, and one magnetic core 6 according to a comparative example, as viewed in the direction orthogonal to the first direction DIR1 and the third direction DIR3. FIG. 6 is a diagram illustrating portions where magnetic flux density is calculated. FIG. 7 is a graph showing an example of changes in magnetic flux density in a case where the first protrusion amount D1 and the second protrusion amount D2 are changed when the offset amount DO is 0.1 mm and the gap width DA is 0.5 mm. FIG. 8 is a graph showing an example of changes in magnetic flux density in a case where the first protrusion amount D1 and the second protrusion amount D2 are changed when the offset amount DO is 0.2 mm and the gap width DA is 0.5 mm. FIG. 9 is a graph showing an example of a change in the back electromotive force constant KE in a case where the first protrusion amount D1 and the second protrusion amount D2 are changed when the offset amount DO is 0.2 mm and the gap width DA is 0.5 mm. FIG. 10 is a graph showing an example of a change in the back electromotive force constant KE in a case where the first protrusion amount D1 and the second protrusion amount D2 are changed when the offset amount DO is 0.2 mm and the gap width DA is 0.3 mm. Note that FIG. 7 to FIG. 10 are results of computer simulation. In addition, regarding the magnetic core 6 according to the comparative example, only differences between the magnetic core 6 and the magnetic core 1 will be described, and description other than the differences will be omitted.

First, the magnetic core 6 according to the comparative example will be described. The magnetic core 6 according to the comparative example is different from the magnetic core 1 in that the tooth tip portion 32 does not include the first protruding portion P1 and the second protruding portion P2 as illustrated in FIG. 5. That is, the tooth tip portion 32 does not protrude from the tooth body portion 31 in the first direction DIR1. Further, the tooth tip portion 32 does not protrude from the tooth body portion 31 in the second direction DIR2.

As illustrated in FIG. 5, the magnetic center C24 of the hard magnetic body 24 is located further in the first direction DIR1 than the magnetic center C1 of the magnetic core 1. Thus, leakage magnetic flux B1 from the hard magnetic body 24 to a region located further in the first direction DIR1 than the tooth body portion 31 is larger than leakage magnetic flux B2 from the hard magnetic body 24 to a region located further in the second direction DIR2 than the tooth body portion 31. Due to the difference between the leakage magnetic flux B1 and the leakage magnetic flux B2, the hard magnetic body 24 receives force in an axial direction along the Z-axis. This force causes noise and vibration in a brushless motor including the magnetic core 6 according to the comparative example.

Then, inventors of the present application have found that, when the tooth tip portion 32 includes the first protruding portion P1 and the second protruding portion P2, the difference between the leakage magnetic flux B1 and the leakage magnetic flux B2 is reduced, and thus noise and vibration generated by the brushless motor 100 can be reduced. In order to confirm the result of study, the inventors of the present application performed computer simulation described below. Note that as described above, the first protrusion amount D1 is the protrusion amount of the first protruding portion P1 from the tooth body portion 31 in the first direction DIR1. Additionally, as described above, the second protrusion amount D2 is the protrusion amount of the second protruding portion P2 from the tooth body portion 31 in the second direction DIR2. Additionally, as described above, the gap width DA is the distance between the inner main surface IS32 and the outer peripheral surface OS24 in the third direction DIR3.

The inventors of the present application calculated a change in magnetic flux density when the first protrusion amount D1 and the second protrusion amount D2 were changed. An average value of magnetic flux densities in a first region A1 is defined as a first direction side magnetic flux density B1AVE. Additionally, an average value of magnetic flux densities in a second region A2 is defined as a second direction side magnetic flux density B2AVE. Note that the first region A1 and the second region A2 are virtual regions that are plane-symmetrical to each other with respect to a plane that is orthogonal to the first direction DIR1 and includes a center of the magnetic core 1. Additionally, as illustrated in FIG. 6, the first region A1 is located further in the first direction DIR1 than the tooth body portion 31. The second region A2 is located further in the second direction DIR2 than the tooth body portion 31.

Note that in FIG. 7 to FIG. 10, when the first protrusion amount D1 and the second protrusion amount D2 are 0 mm, the magnetic core is the magnetic core 6 according to the comparative example. Further, when the first protrusion amount D1 and the second protrusion amount D2 are larger than 0 mm, the magnetic core is the magnetic core 1.

According to FIG. 7, when the offset amount DO is 0.1 mm and the gap width DA is 0.5 mm, a difference (B1AVE−B2AVE) between the first direction side magnetic flux density B1AVE and the second direction side magnetic flux density B2AVE decreases as the first protrusion amount D1 and the second protrusion amount D2 increase. Thus, as the first protrusion amount D1 and the second protrusion amount D2 increase, the noise and vibration generated by the brushless motor 100 can be reduced. As a result, according to the brushless motor 100, the noise and vibration generated by the brushless motor can be reduced.

According to FIG. 8, also when the offset amount DO is 0.2 mm and the gap width DA is 0.5 mm, the difference (B1AVE−B2AVE) between the first direction side magnetic flux density B1AVE and the second direction side magnetic flux density B2AVE decreases as the first protrusion amount D1 and the second protrusion amount D2 increase. Thus, as the first protrusion amount D1 and the second protrusion amount D2 increase, the noise and vibration generated by the brushless motor 100 can be reduced. As a result, according to the brushless motor 100, the noise and vibration generated by the brushless motor can be reduced.

As described above, with the brushless motor 100, the noise and vibration generated by the brushless motor can be reduced without requiring a magnetic shielding member for shielding the coil 13 against leakage magnetic flux from the hard magnetic body 24.

Further, the inventors of the present application have also found that when the tooth tip portion 32 includes the first protruding portion P1 and the second protruding portion P2, the back electromotive force constant KE changes in accordance with changes in the first protrusion amount D1 and the second protrusion amount D2. The inventors of the present application calculated a change in the back electromotive force constant KE when the first protrusion amount D1 and the second protrusion amount D2 were changed. Note that the back electromotive force constant KE is a constant obtained by dividing back electromotive force generated between both ends of the coil 13 by angular velocity of the rotor 20.

According to FIG. 9, when the offset amount DO is 0.2 mm and the gap width DA is 0.5 mm, the back electromotive force constant KE increases as the first protrusion amount D1 and the second protrusion amount D2 increase in a range of 0 mm≤the first protrusion amount D1 and the second protrusion amount D2≤0.6 mm. In addition, in a range of 0.6 mm<the first protrusion amount D1 and the second protrusion amount D2≤2 mm, the back electromotive force constant KE decreases as the first protrusion amount D1 and the second protrusion amount D2 increase. Further, the back electromotive force constant KE in a range of 0 mm<the first protrusion amount D1 and the second protrusion amounts D2<1.5 mm (=three times the gap width DA) is larger than the back electromotive force constant KE when the first protrusion amount D1 and the second protrusion amount D2 are 0 mm (in the case of the brushless motor including the magnetic core 6 according to the comparative example). Thus, as long as the first protrusion amount D1 and the second protrusion amount D2 are smaller than three times the gap width DA, the back electromotive force constant KE can be increased.

According to FIG. 10, when the offset amount DO is 0.2 mm and the gap width DA is 0.3 mm, the back electromotive force constant KE increases as the first protrusion amount D1 and the second protrusion amount D2 increase in a range of 0 mm≤the first protrusion amount D1 and the second protrusion amount D2≤0.4 mm. In addition, in a range of 0.4 mm<the first protrusion amount D1 and the second protrusion amount D2≤0.8 mm, the back electromotive force constant KE decreases as the first protrusion amount D1 and the second protrusion amount D2 increase. Further, the back electromotive force constant KE in a range of 0 mm<the first protrusion amount D1 and the second protrusion amounts D2<0.9 mm (=three times the gap width DA) is larger than the back electromotive force constant KE when the first protrusion amount D1 and the second protrusion amount D2 are 0 mm (in the case of the brushless motor including the magnetic core 6 according to the comparative example). Thus, as long as the first protrusion amount D1 and the second protrusion amount D2 are smaller than three times the gap width DA, the back electromotive force constant KE can be increased.

The reason why the back electromotive force constant KE changes in accordance with the changes in the first protrusion amount D1 and the second protrusion amount D2 will be described.

As the first protrusion amount D1 and the second protrusion amount D2 are increased from 0, magnetic flux taken into the magnetic core 1 from the tooth tip portion 32, out of magnetic flux generated by the hard magnetic body 24, increases. When 0 mm<the first protrusion amount D1 and the second protrusion amount D2 the gap width DA, most of the increased magnetic flux passes through an inside of the tooth body portion 31, and thus the back electromotive force constant KE increases. On the other hand, when the gap width DA<the first protrusion amount D1 and the second protrusion amount D2, a part of the increased magnetic flux is directed toward a tip of the tooth tip portion 32 in the first direction DIR1 or to a tip of the tooth tip portion 32 in the second direction DIR2, and circulates inside and outside the tooth tip portion 32 in a vicinity of the tip and does not pass through the inside of the tooth body portion 31, thus the back electromotive force constant KE decreases.

### Other Embodiments

The rotating electric machine according to the present disclosure is not limited to the brushless motor 100, and can be modified within the scope of the present disclosure.

Note that it is sufficient that the rotating electric machine has a structure in which a rotor is rotated by electricity or a structure in which electricity is generated by rotation of a rotor. Examples of the rotating electric machine include a brushless motor, a permanent magnet synchronous motor, and a permanent magnet synchronous generator. In this case, the rotating electric machine may include a brush.

Note that the brushless motor 100 may be a brushless motor of an outer rotor type. In this case, the tooth body portion 31 extends from the core back portion 2 in a direction opposite to the third direction DIR3. Even in this case, the tooth tip portion 32 is formed at the tip of the tooth body portion 31. Since the back electromotive force constant KE is the constant obtained by dividing the back electromotive force generated between both the ends of the coil 13 by the angular velocity of the rotor 20, even when the brushless motor 100 is a brushless motor of the outer rotor type, it is possible to estimate that the back electromotive force constant KE can be increased by setting the first protrusion amounts D1 and the second protrusion amount D2 to be smaller than three times the gap width DA, as in the above-described embodiment. Thus, even when the brushless motor 100 is a brushless motor of the outer rotor type, the same effect as that in the case where the brushless motor 100 is a brushless motor of the inner rotor type is obtained.

Note that when the brushless motor 100 is a brushless motor of the outer rotor type, the gap width DA may be a distance in the third direction DIR3 between an outer main surface of the tooth tip portion 32 and the outer peripheral surface OS24 of the hard magnetic body 24.

Note that when the brushless motor 100 is a brushless motor of the inner rotor type, the tooth body portion 31 need not extend from the core back portion 2 in the third direction DIR3. In this case, it is sufficient that the tooth body portion 31 extends inward toward the rotation axis of the rotor 20. Since the back electromotive force constant KE is the constant obtained by dividing the back electromotive force generated between both the ends of the coil 13 by the angular velocity of the rotor 20, when the brushless motor 100 is a brushless motor of the inner rotor type, it is possible to estimate that the back electromotive force constant KE can be increased by setting the first protrusion amount D1 and the second protrusion amount D2 to be smaller than three times the gap width DA, as in the above-described embodiment, as long as the tooth body portion 31 extends inward toward the rotation axis of the rotor 20. Thus, in the case where the brushless motor 100 is a brushless motor of the inner rotor type, even when the tooth body portion 31 extends inward toward the rotation axis of the rotor 20, the same effect as that in the case where the tooth body portion 31 extends from the core back portion 2 in the third direction DIR3 is obtained.

Note that when the brushless motor 100 is a brushless motor of the outer rotor type, the tooth body portion 31 need not extend from the core back portion 2 in the opposite direction to the third direction DIR3. In this case, it is sufficient that the tooth body portion 31 extends outward (away from the rotation axis of the rotor 20). Since the back electromotive force constant KE is the constant obtained by dividing the back electromotive force generated between both the ends of the coil 13 by the angular velocity of the rotor 20, when the brushless motor 100 is a brushless motor of the outer rotor type, it is possible to estimate that the back electromotive force constant KE can be increased by setting the first protrusion amount D1 and the second protrusion amount D2 to be smaller than three times the gap width DA, as in the above-described embodiment, as long as the tooth body portion 31 extends outward. Thus, in the case where the brushless motor 100 is a brushless motor of the outer rotor type, even when the tooth body portion 31 extends outward, the same effect as that in the case where the tooth body portion 31 extends from the core back portion 2 in the third direction DIR3 when the brushless motor 100 is a brushless motor of the inner rotor type is obtained.

Note that the brushless motor 100 is not limited to a brushless motor of the single-shaft type. The brushless motor 100 may be, for example, a brushless motor of a double-shaft type.

Note that each of the first bearing 11a and the second bearing 11b is not limited to the ball bearing.

Note that it is sufficient that a material of each of the first housing 12a and the second housing 12b is a material having high rigidity.

Note that the number of coils 13 is not limited to nine and the number of magnetic cores 1 is not limited to nine.

Note that the magnetic core 1 may be manufactured by laminating electromagnetic steel sheets.

Note that each of the two end surfaces and the inner main surface of the core back portion 2 may be a curved surface. Further, each of the outer main surface and the two side surfaces of the core back portion 2 may be a flat surface.

The magnetic center C24 of the hard magnetic body 24 and the magnetic center C1 of the magnetic core 1 may coincide with each other in the first direction DIR1. In this case, the offset amount DO is zero. Even in this case, the same effect as that of the brushless motor 100 is obtained.

Note that it is sufficient that the tooth tip portion 32 includes at least one of the first protruding portion P1 and the second protruding portion P2.

Note that the back electromotive force constant KE may be an induced voltage constant, a power generation constant, or a torque constant.

The present disclosure has the following configurations.

(1) A rotating electric machine including: a rotor including a magnetized hard magnetic body; and a magnetic core including a tooth portion, wherein the tooth portion includes: a tooth body portion extending along a direction that intersects a rotation axis of the rotor, and a tooth tip portion at a tip of the tooth body portion and facing the magnetized hard magnetic body, the tooth tip portion includes a first protruding portion protruding from the tooth body portion in an axial direction along the rotation axis, and a first protrusion amount of the first protruding portion from the tooth body portion is smaller than three times a gap width between the magnetized hard magnetic body and the tooth tip portion.

(2) The rotating electric machine according to (1), wherein the tooth tip portion includes a second protruding portion protruding from the tooth body portion in a direction opposite to the first protruding portion in the axial direction along the rotation axis, and a second protrusion amount of the second protruding portion from the tooth body portion is smaller than three times the gap width.

(3) The rotating electric machine according to (1) or (2), wherein a magnetic center of the magnetized hard magnetic body and a magnetic center of the magnetic core are shifted from each other in the axial direction along the rotation axis.

(4) The rotating electric machine according to (1) or (2), wherein a magnetic center of the magnetized hard magnetic body and a magnetic center of the magnetic core coincide with each other in the axial direction along the rotation axis.

(5) The rotating electric machine according to any one of (1) to (4), wherein the magnetic core is a molded body comprising a soft magnetic powder.

### REFERENCE SIGNS LIST

1 MAGNETIC CORE
2 CORE BACK PORTION
3 TOOTH PORTION
6 MAGNETIC CORE
10 STATOR ASSEMBLY
11 BEARING
11a FIRST BEARING
11b SECOND BEARING
12 HOUSING
12a FIRST HOUSING
12b SECOND HOUSING
13 COIL
20 ROTOR
21 SHAFT
22 ROTOR MEMBER
23 SOFT MAGNETIC BODY
24 HARD MAGNETIC BODY
31 TOOTH BODY PORTION
32 TOOTH TIP PORTION
100 BRUSHLESS MOTOR
A1 FIRST REGION
A2 SECOND REGION
B1, B2 MAGNETIC FLUX
B1AVE FIRST DIRECTION SIDE MAGNETIC FLUX DENSITY
B2AVE SECOND DIRECTION SIDE MAGNETIC FLUX DENSITY
C1, C24 MAGNETIC CENTER
D1 FIRST PROTRUSION AMOUNT
D2 SECOND PROTRUSION AMOUNT
DA GAP WIDTH
DIR1 FIRST DIRECTION
DIR2 SECOND DIRECTION
DIR3 THIRD DIRECTION
DIR4 FOURTH DIRECTION
DO OFFSET AMOUNT
E1 FIRST END SURFACE
E2 SECOND END SURFACE
IS32 INNER MAIN SURFACE
KE BACK ELECTROMOTIVE FORCE CONSTANT

1. A rotating electric machine comprising:
a rotor including a magnetized hard magnetic body; and
a magnetic core including a tooth portion, wherein the tooth portion includes:
a tooth body portion extending along a direction that intersects a rotation axis of the rotor, and
a tooth tip portion at a tip of the tooth body portion and facing the magnetized hard magnetic body,
the tooth tip portion includes a first protruding portion protruding from the tooth body portion in an axial direction along the rotation axis, and
a first protrusion amount of the first protruding portion from the tooth body portion is smaller than three times a gap width between the magnetized hard magnetic body and the tooth tip portion.

2. The rotating electric machine according to claim 1, wherein
the tooth tip portion includes a second protruding portion protruding from the tooth body portion in a direction opposite to the first protruding portion in the axial direction along the rotation axis, and
a second protrusion amount of the second protruding portion from the tooth body portion is smaller than three times the gap width.

3. The rotating electric machine according to claim 2, wherein a magnetic center of the magnetized hard magnetic body and a magnetic center of the magnetic core are shifted from each other in the axial direction along the rotation axis.

4. The rotating electric machine according to claim 2, wherein a magnetic center of the magnetized hard magnetic body and a magnetic center of the magnetic core coincide with each other in the axial direction along the rotation axis.

5. The rotating electric machine according to claim 1, wherein a magnetic center of the magnetized hard magnetic body and a magnetic center of the magnetic core are shifted from each other in the axial direction along the rotation axis.

6. The rotating electric machine according to claim 1, wherein a magnetic center of the magnetized hard magnetic body and a magnetic center of the magnetic core coincide with each other in the axial direction along the rotation axis.

7. The rotating electric machine according to claim 1, wherein the magnetic core is a molded body comprising a soft magnetic powder.

8. The rotating electric machine according to claim 1, further comprising a coil wound around the tooth body portion.

9. The rotating electric machine according to claim 1, wherein the tooth body portion extends toward the rotation axis of the rotor.

10. A rotating electric machine comprising:
a rotor including a magnetized hard magnetic body; and
a magnetic core including a tooth portion, wherein the tooth portion includes:
a tooth body portion extending toward a rotation axis of the rotor, and
a tooth tip portion at a tip of the tooth body portion and facing the magnetized hard magnetic body,
the tooth tip portion includes a first protruding portion protruding from the tooth body portion in an axial direction along the rotation axis, and a second protruding portion protruding from the tooth body portion in a direction opposite to the first protruding portion in the axial direction along the rotation axis, and
a first protrusion amount of the first protruding portion from the tooth body portion is smaller than three times a gap width between the magnetized hard magnetic body and the tooth tip portion, and a second protrusion amount of the second protruding portion from the tooth body portion is smaller than three times the gap width.

11. The rotating electric machine according to claim 10, wherein a magnetic center of the magnetized hard magnetic body and a magnetic center of the magnetic core are shifted from each other in the axial direction along the rotation axis.

12. The rotating electric machine according to claim 10, wherein a magnetic center of the magnetized hard magnetic body and a magnetic center of the magnetic core coincide with each other in the axial direction along the rotation axis.

13. The rotating electric machine according to claim 10, wherein the magnetic core is a molded body comprising a soft magnetic powder.

14. The rotating electric machine according to claim 10, further comprising a coil wound around the tooth body portion.
